(19) United States
(12) Patent Application Publication
(10) Pub. No.: US 2006/0157887 A1
(43) Pub. Date: Jul. 20, 2006

(54) Method and device for the production of plastic profiles

(76) Inventor: Meinhard Schwaiger, Linz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/562,208

(22) PCT Filed: Jun. 24, 2004
(86) PCT No.: PCT/AT04/00221

§ 371 Date: Feb. 27, 2006

(30) Foreign Application Priority Data
Jun. 27, 2003 (AT) GM 450/2003

(51) Int. Cl. B29C 47/00

(52) U.S. Cl. 264/210.2; 425/378.1; 425/131.1

(57) ABSTRACT

The invention relates to a method for producing plastic profiles, in which a first profile is initially produced by extruding a profiled bar (6) through an extruder (2) and molding said profiled bar (6) in a first extrusion die nozzle (3a) that is connected to the extruder (2), whereupon the profiled bar (6) is calibrated in a first calibrating die (4a) located on a calibrating table (5) and chilled. The extrusion die nozzle (3; 3a, 3b) and the calibrating die (4; 4a, 4b) have to be replaced so as to be able to produce different profiles. In order to keep idle times as short as possible while changing dies, freely movable manipulating devices (9, 18) are used for replacing the extrusion die nozzle (3; 3a, 3b) and the calibrating die (4; 4a, 4b).

The invention relates to a method for producing plastic profiles, in which a first profile is initially produced by extruding a profiled bar through an extruder and molding said profiled bar in a first extrusion die nozzle that is connected to the extruder, whereupon the profiled bar is calibrated in a first calibrating die located on a calibrating table and is chilled, whereupon the first extrusion die nozzle is separated from the extruder and a second extrusion die nozzle is attached to the extruder and/or the first calibrating die is removed from the calibrating table and a second calibrating die is attached in order to produce thereafter a second profile.

Flexibility plays an important role in industrial extrusion of profiles for economic reasons. Flexibility means among other things that a production line for producing plastic profiles needs to be converted as quickly as possible from the production of one profile to the production of another profile. Extrusion die nozzles and calibrating dies are usually exchanged in such a conversion. A crane is usually used for changing the calibrating dies which is usually provided in the ceiling area of the respective production hall. During the conversion of the extrusion line, the extrusion die nozzle is severed at first from the extruder, suspended on a crane and moved to a storage or service position. Thereafter, the second extrusion die nozzle is taken up by the crane and transported to the extruder in order to be mounted there. Especially in cases where the crane is busy it may occur that waiting periods ensue as a result of such manipulations, which waiting periods slow down the production change in an undesirable manner. Since the new extrusion die nozzle is usually preheated in order to speed up the start-up process of the extrusion, it may occur as a result of the described delays that the extrusion die nozzle cools out, thus leading to an increase of rejects in production. Calibrating dies are subjected to cooling water for the removal of heat from the extruded profile and with vacuum for exact shaping. In the change of calibrating dies, cooling water hoses and vacuum tubes need to be detached or attached by means of special couplings, for which purpose it is necessary to additionally cut off or reactivate the supply with cooling water and with vacuum, which is a process which additionally takes time.

DE 299 17 344 U shows an apparatus for calibrating extruded profiles, comprising die holding devices which are movable transversally to the direction of extrusion. Although a change of the die is possible in a relatively rapid manner and this reduces the standstill periods, such an apparatus widens the extrusion line and therefore needs a large amount of space. Moreover, the work processes required for changing the die are not reduced but only shifted temporally in order to disturb production to a lesser extent. Moreover, the extrusion die can only be changed in a conventional manner.

U.S. Pat. No. 5,525,052 A describes an extruder with a changer apparatus for the extrusion die. Such a relatively complex apparatus cannot be used for the extrusion of plastic profiles because the mechanical stability cannot be ensured as a result of the pressure conditions prevailing in the extruder.

It is the object of the present invention to avoid the time losses as described above and to provide a method for producing plastic profiles in which there is an increased flexibility by achieving a rapid change in production.

It is provided in accordance with the invention that prior to severing the first extrusion die nozzle the second extrusion die nozzle is made available on a freely movable first manipulating device in the region of the extruder, whereupon the first extrusion die nozzle is removed from the extruder by a nozzle lifting apparatus of the first manipulating device and the second extrusion die nozzle is brought to the extruder to the docking position by the nozzle lifting apparatus and/or that prior to the dismounting of the first calibrating die the second calibrating die is made available in the region of the calibrating table on a freely movable second manipulating device, whereupon the first calibrating die is removed from the calibrating table by a calibrating die lifting device of the second manipulating device preferably transversally to the direction of extrusion and the second calibrating die is brought to the calibrating table to the docking position by a calibrating die lifting apparatus preferably transversally to the direction of extrusion.

The relevant aspect in the method in accordance with the invention is that during the change of the extrusion die nozzle the second extrusion die nozzle is already made available in the direct vicinity of the extruder before the first extrusion die nozzle is dismounted. A further relevant advantage of the invention is that the first manipulating device itself comprises a lifting apparatus which allows bringing the extrusion die nozzle to the respective docking position, which extrusion die nozzle cannot be manipulated manually for weight reasons.

It is preferably provided that the first extrusion die nozzle is removed from the extruder by a first nozzle lifting apparatus of the first manipulating device and the second extrusion die nozzle is brought to the extruder to the docking position by a second nozzle lifting apparatus of the first manipulating device. The exchanging process of the extrusion die nozzle can be accelerated further by providing two separate nozzle lifting apparatuses.

It is provided in an especially preferable embodiment of the method in accordance with the invention that the extrusion die nozzle on the first manipulating device is preheated. Since the preheating is thus performed until directly prior to the actual attachment of the extrusion die nozzle to the extruder, precise thermostatization is possible and cooling can be prevented reliably. As a result, the extrusion process can already be started with an optimal temperature of the extrusion die nozzle. Rejects can thus be reduced substantially.

The present invention further relates to an apparatus for manipulating extrusion die nozzles which is configured as a movable first manipulating device, comprising a nozzle lifting apparatus for receiving extrusion die nozzles. Since the apparatus in accordance with the invention renders the use of a crane superfluous, the changing process of the extrusion die nozzle will become independent of the respective work-load of the crane. A further advantage is that by relieving the crane other work processes can be accelerated in which the crane is required.

It is especially advantageous when the lifting apparatus comprises a first lifting arm for receiving a first extrusion die nozzle and a second lifting arm for receiving a second extrusion die nozzle, and especially when the first and second lifting arm are movable independent from each other. Since the lifting arms can be controlled in a more precise manner than the crane, the actual process of fastening the second extrusion die nozzle is accelerated additionally.

Since the calibrating dies are generally also changed during the exchange of the extrusion die nozzles, it is especially advantageous when further a second manipulating device for a calibrating die is provided which preferably comprises a lifting apparatus for the calibrating die and a displacement unit for the calibrating die, e.g. with roller or slide bearing. It can further be provided that the lifting apparatus for the calibrating die comprises a first lifting arm for receiving a first calibrating die and a second lifting arm for receiving a second calibrating die. The first and second lifting arm of the lifting apparatus for the calibrating die are preferably movable independent from each other. The second manipulating device is advantageously provided with a configuration so as to be fixable and dockable to the calibrating table. As a result, the same can be displaced with the calibrating table in the direction of extrusion. It is further provided in an especially preferred embodiment that the calibrating die can be connected via an automatic coupling device to cooling water supply and/or vacuum lines of the calibrating table. On removing the first calibrating die from the calibrating table, this allows severing cooling water and/or vacuum supply lines automatically from the first calibrating die and, after displacement of the second calibrating die to the calibrating table to the docking position, automatically connecting the same to the second calibrating die.

The manipulation is made easier especially in such a way that the first and/or second manipulating device are provided with an automotive configuration.

The exchange of the calibrating die is made in such a way that the first calibrating die is removed by a lifting apparatus for the first calibrating die of the second manipulating device and the second calibrating die is brought by a lifting apparatus for the second calibrating die of the second manipulating device to the calibrating table to the docking position. The removal of the first calibrating die and the supply of the second calibrating die can occur from the same longitudinal side or from different longitudinal sides of the calibrating table. In the second case, the calibrating table is configured in such a way that both on the operator's side as well as on the side averted from the operator no elements which are fixedly attached to the calibrating table will project beyond the upper edge of the so-called mounting frame.

In the case of a calibrating die which can be connected to cooling water and/or vacuum supply lines it is especially advantageous when on removing the first calibrating die from the calibrating table the cooling water and/or vacuum supply lines are severed automatically from the first calibrating die and are connected to the second calibrating die after the transfer of the second calibrating die to the docking position to the calibrating table. Time for manually connecting and disconnecting the lines can thus be saved. Numerous hose connections for the supply with cooling water or vacuum can be omitted when the automatic coupling unit is arranged on a mounting frame of the calibrating table. The coupling unit comprises a plurality of pin-like couplings which are tightly sealed in the uncoupled state. Special openings are provided in the base plate of the calibrating die which can receive the pin-like couplings. Once the calibrating die is placed on the mounting frame, the cooling and vacuum supplies are simultaneously made automatically by means of the pin-like couplings without having to couple a hose connection manually. The calibrating table is prepared for the maximum required number of cooling and vacuum connections, whereas the calibrating die can have an individual number of cooling water and vacuum connection openings in the base plate. The supply connections required for the respective profile production are activated by a special gudgeon in the base plate for example, whereas the supply connections not required remain inactive (e.g. opening bore without gudgeon). The second calibrating die is positioned precisely on the mounting frame by moving vertically upward and is fixed on the same, with the required connections being made automatically with the cooling water and vacuum supply lines.

An especially preferred embodiment of the invention provides that the transversal displacement unit is arranged between the calibrating die and the mounting frame of the calibrating table and rests on the transversal displacement unit by vertical lowering of the mounting frame of the calibrating die and the cooling water and vacuum supply lines are severed as a result. This allows minimizing the manipulations to be performed manually and to automate the changing process.

The invention is now explained below in closer detail by reference to the drawings, wherein:

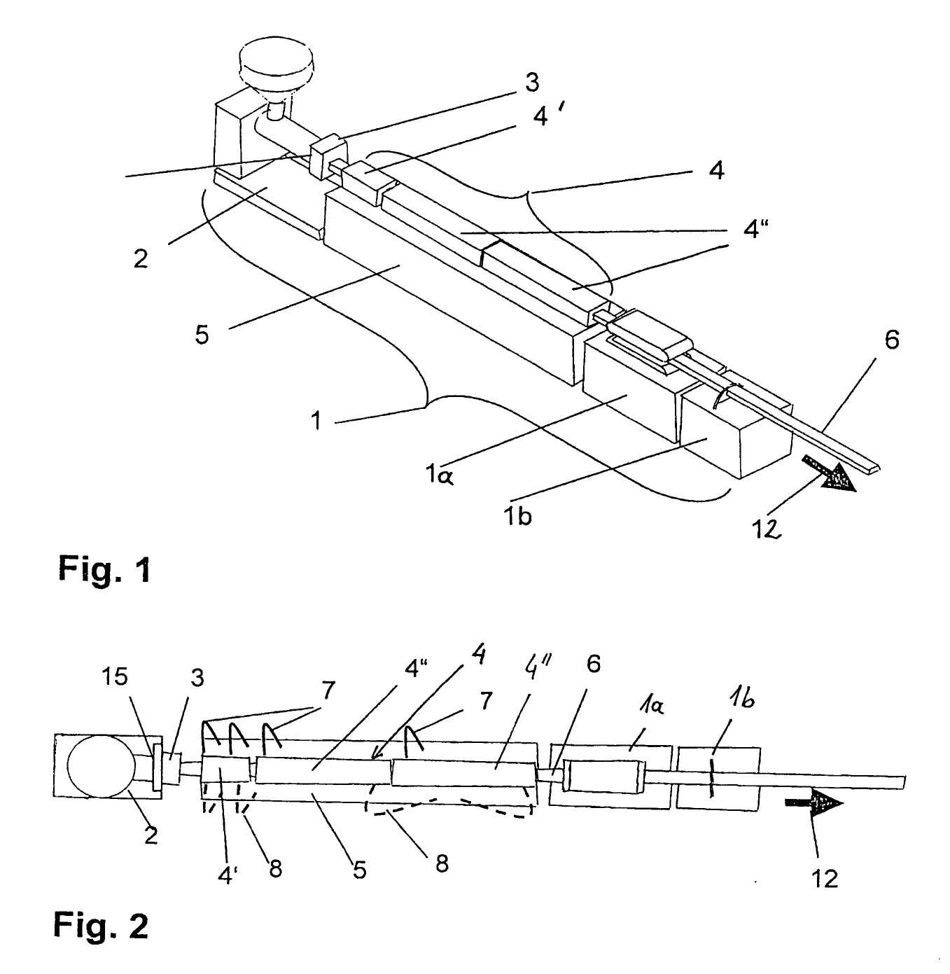

FIG. 1 schematically shows an extrusion plant in an oblique view;

FIG. 2 shows a layout of said extrusion plant;

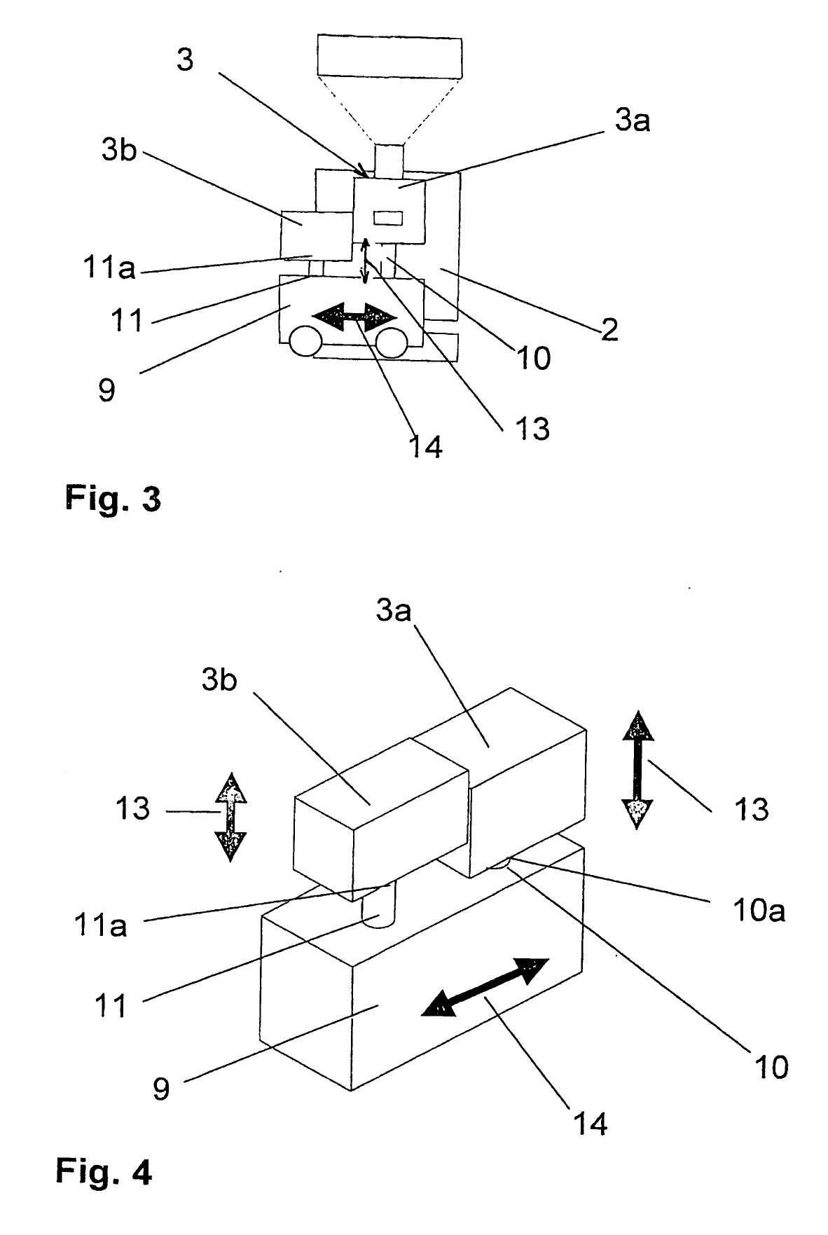

FIG. 3 shows a changing process of an extrusion die nozzle;

FIG. 4 shows a first manipulating device in an oblique view;

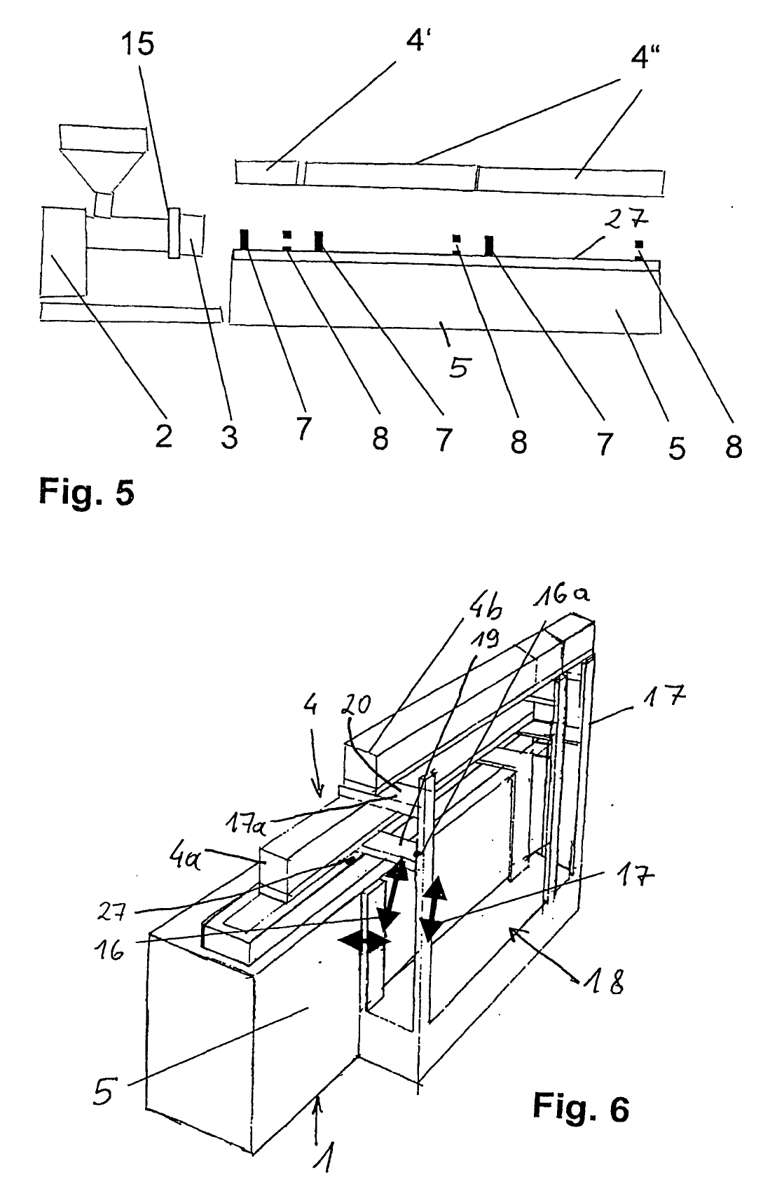

FIG. 5 shows a docking process of a calibrating die to the calibrating table;

FIG. 6 shows a changing process of a calibrating die with a second manipulating device, configured with two lifting arms receiving the calibrating die;

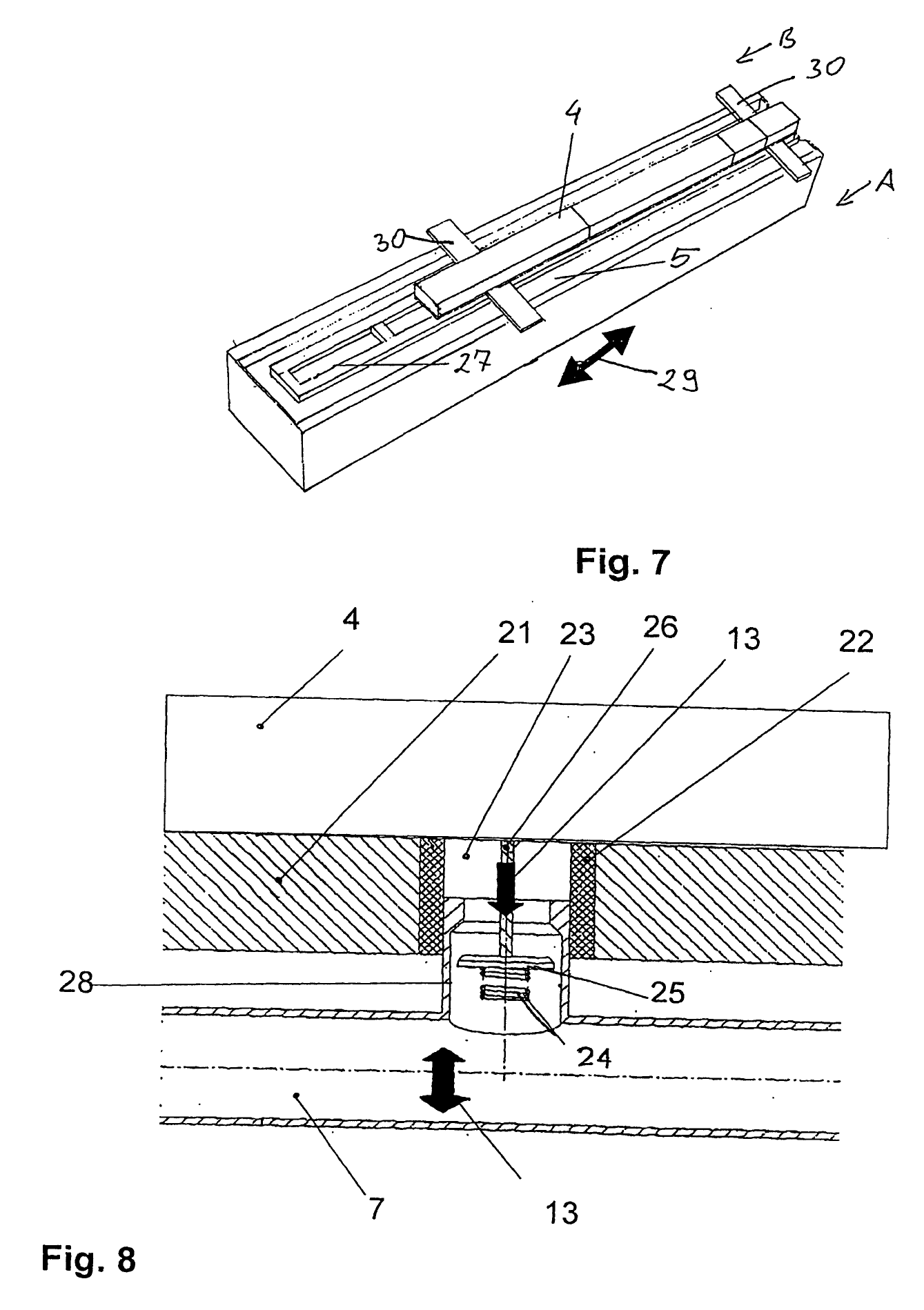

FIG. 7 shows an embodiment with a second manipulating device, configured without lifting arms for receiving the calibrating die, but with a displacement unit for the calibrating die, and

FIG. 8 shows an automatic coupling unit in a sectional view.

The extrusion plant 1 shown in FIGS. 1, 2 and 5 consists of an extruder 2, an extrusion die nozzle 3, a calibrating die 4 and a dry calibrator 4′ and a wet calibrator 4″ and a calibrating table 5, a caterpillar take-off 1a for profiles and a profile saw 1b, and is used for producing a profile train 6 made of plastic, e.g. a pipe, a window profile or the like. As is shown in FIG. 2, the calibrating die 4 is connected to cooling water connecting lines 7 and vacuum connecting lines 8 on the calibrating table 5. Said cooling water and vacuum connecting lines 7, 8 must be uncoupled manually from the current first calibrating die 4 in known extrusion plants 1 during each change of the calibrating die 4 and must be connected to a new second calibrating die. The number of connecting lines differs individually from calibrating die to calibrating die.

In order to enable a simple and rapid change of the extrusion die nozzle 3, the extrusion die nozzle 3b provided for the subsequent production is mounted on a movable first manipulating device 9 while production still continues with the first extrusion die nozzle 3a and is brought to or held at a preheating temperature. The second extrusion die nozzle 3b is brought with the first manipulating device 9 between extruder 2 and calibrating table 5 in the transversal direction 14 relative to the extrusion direction 12, such that the first lifting arm 10a of the first manipulating device 9 is situated beneath the first extrusion die nozzle 3a. The first lifting arm 10a is moved with the first nozzle lifting apparatus 10 in the vertical direction 13 until the first extrusion die nozzle 3a. After switching off the extrusion plant 1, the first extrusion die nozzle 3a is severed from the extruder 2, e.g. by means of a clamping flange connection, with the first extrusion die nozzle 3a being held entirely by the first nozzle lifting apparatus 10 of the first manipulating device 9. Thereafter, the position of the first and second extrusion die nozzle 3a, 3b is displaced in the transversal direction 14 in such a way that the second extrusion die nozzle 3b is brought to the position of the extruder flange 15. The second lifting arm 11a with the second extrusion die nozzle 3a is lifted via the second nozzle lifting apparatus 11 to the correct mounting position. The extrusion plant 1 can be re-started again after fixing the second extrusion die nozzle 3b to the extruder 2 and the coupling of the power and sensor lines of extruder 2 with the second extrusion die nozzle 3b.

At the same time with the change of the extrusion die nozzle 3 it is also possible to carry out a change of the calibrating die 4, as is schematically shown in FIG. 5 and FIG. 6. While the production is still running with the first calibrating die 4a, the second calibrating die 4b required for the subsequent production is centered and placed on the lifting arm 17a of a second lifting apparatus 17 for the calibrating die of a freely movable second manipulating device 18. The second manipulating device 18 with the second calibrating die 4b is moved to the calibrating table 5 of the extrusion plant 1 and is coupled with and fixed to calibrating table 5. After stopping the current production, the first calibrating die 4a with mounting frame 27 of the calibrating table 5 is moved to a position of height suitable for the transfer and the lifting arm 16a of the lifting apparatus 16 of the first calibrating die of the second manipulating device 18 is pushed beneath the first calibrating die 4a. The cooling water connecting lines 7 and the vacuum connecting lines 8 are severed, and optionally the connection between calibrating die 4 and calibrating table 5 is severed. The first calibrating die 4a is lifted slightly by the lifting apparatus 16 for the first calibrating die and thereafter brought to a basic position defined by a rear position by at least one first displacement unit 19 along the first lifting arm 16a. The second lifting arm 17a with the second calibrating die 4b is displaced vertically by means of the lifting apparatus 17 for the second calibrating die. The second calibrating die 4b is displaced by means of a second displacement unit 20 along the second lifting arm 17a in the transversal direction and the second calibrating die 4b is placed on the mounting frame 27 of the calibrating table 5 in the centering position. The second lifting arm 17a is moved thereupon to its basic position and the second calibrating die 4b is connected with the cooling water and vacuum connecting lines 7, 8 by lifting the mounting frame 27. While the production is started, the second manipulating device 18 with the first calibrating die 4a can be moved away from the production line.

By using the manipulating devices 9, 18, which can be provided with an automotive configuration, further transport means and hoists can be omitted and production standstill periods can be kept as short as possible.

If the calibrating table 5 comprises a mounting frame 27 with an automatic coupling unit 28 for automatically coupling and decoupling the cooling water and vacuum supply lines 7, 8, further manual work steps can be saved and the standstill periods can be reduced even further.

FIG. 7 shows a changing process for a calibrating die with a second manipulating device (not shown here in closer detail) which is provided with only one lifting apparatus for the calibrating die and in which the change of the calibrating die occurs from one side A to the other side B, such that the calibrating die 4 is placed on a transversal displacement unit 30 which is configured with a roller guide means or the like. The decoupling of the cooling water and vacuum connecting lines occurs simultaneously. The calibrating die 4 can be displaced transversally to the direction of extrusion 29 and can thereafter be deposited on a laterally positioned die changing carriage (not shown in closer detail). After the removal of the fist calibrating die from the working chamber, the second calibrating die can be pushed into the working chamber.

FIG. 8 shows such an automatic coupling unit 28 in detail. The base plate of the calibrating die 4 is designated with reference numeral 21. The base plate 21 comprises connecting openings 23 sealed by flexible collars 22 for coupling units 28 of cooling water or vacuum connecting lines 7, 8. A valve reed 25 which is loaded by a spring 23 for example is arranged within the coupling unit 28. When the calibrating die 4 and/or the mounting frame 27 with the cooling water connecting lines 7 or vacuum connecting lines 8 is moved in the vertical direction towards each other according to arrows 13, a pin 26 which is die-proof acts upon the valve reed 25 against the force of spring 24 and thus opens the coupling unit 28.

The calibrating table 5 is prepared for the maximum required number of cooling water and vacuum supply lines 7, 8, whereas the calibrating die 4 can have an individual lower number of connecting openings 23. The connecting openings required for the respective profile production are activated by the pins 26 in the base plate 21, whereas supply connections not required remain inactive.

1. A method for producing plastic profiles, in which a first profile is initially produced by extruding a profiled bar (6) through an extruder (2) and molding said profiled bar in a first extrusion die nozzle (3a) that is connected to the extruder (2), whereupon the profiled bar is calibrated in a first calibrating die (4a) arranged on a calibrating table (5) and is chilled, whereupon the first extrusion die nozzle (3a) is separated from the extruder (2) and a second extrusion die nozzle (3b) is attached to the extruder (2) and/or the first calibrating die (4a) is removed from the calibrating table (5) and a second calibrating die (4b) is attached in order to produce thereafter a second profile, characterized in that prior to severing the first extrusion die nozzle (3a) the second extrusion die nozzle (3b) is made available on a freely movable first manipulating device (9) in the region of the extruder (2), whereupon the first extrusion die nozzle (3a) is removed from the extruder (2) by a nozzle lifting apparatus (10, 11) of the first manipulating device (9) and the second extrusion die nozzle (3b) is brought to the extruder (2) to the docking position by the nozzle lifting apparatus (10, 11) and/or that prior to the dismounting of the first calibrating die (4a) the second calibrating die (4b) is made available in the region of the calibrating table (5) on a freely movable second manipulating device (18), whereupon the first calibrating die (4a) is removed from the calibrating table (5) by a calibrating die lifting device (16, 17) of the second manipulating device (18) preferably transversally to the direction of extrusion (12), and the second calibrating die (4b) is brought to the calibrating table (5) to the docking position by a calibrating die lifting apparatus (16, 17) preferably transversally to the direction of extrusion (12).

2. A method according to claim 1, characterized in that the first extrusion die nozzle (3a) is removed from the extruder (2) by a first nozzle lifting apparatus (10) of the first manipulating device (9) and the second extrusion die nozzle (3b) is brought to the extruder (2) to the docking position by a second nozzle lifting apparatus (11) of the first manipulating device (9).

3. A method according to one of the claims 1 or 2, characterized in that the second extrusion die nozzle (3b) is preheated on the first manipulating device (9).

4. A method according to one of the claims 1 to 3, characterized in that the first calibrating die (4a) is removed from the calibrating table (5) by a first calibrating die lifting apparatus (16) of the second manipulating device (18) and the second calibrating die (4b) is brought to the calibrating table (5) to the docking position by a second calibrating die lifting apparatus (17) of the second manipulating device (18).

5. A method according to one of the claims 1 to 4, cooling water and/or vacuum supply lines (7,) being connected to the calibrating die (4) attached to the calibrating table (5), characterized in that upon removing the first calibrating die (4a) from the calibrating table (5) cooling water and/or vacuum supply lines (7, 8) are severed automatically from the first calibrating die (4a) and, after transferring the second calibrating die (4b) to the calibrating table (5) to the docking position, are connected automatically to the second calibrating die (4b).

6. A method according to one of the claims 1 to 5, characterized in that the removal of the first calibrating die (4a) from and the transfer of the second calibrating die (4b) to the calibrating table (5) occurs from the same longitudinal side of the calibrating table (5).

7. A method according to one of the claims 1 to 5, characterized in that the removal of the first calibrating die (4a) from and the transfer of the second calibrating die (4b) to the calibrating table (5) occurs from different longitudinal sides of the calibrating table (5).

8. An apparatus for manipulating extrusion die nozzles (3; 3a, 3b) which is configured as a movable first manipulating device (9), comprising at least one nozzle lifting apparatus (10, 11) for receiving extrusion die nozzles (3; 3a, 3b).

9. An apparatus according to claim 8, characterized in that lifting apparatus (10, 11) for the extrusion die nozzle comprises a first lifting arm (11a) for receiving a first extrusion die nozzle (3a) and a second lifting arm (11a) for receiving a second extrusion die nozzle (3b).

10. An apparatus according to claim 9, characterized in that the first and second lifting arm (10a, 11a) are movable independent from each other.

11. An apparatus according to one of the claims 8 to 10, characterized in that a heating apparatus for at last one extrusion die nozzle (3; 3a, 3b) is provided.

12. An apparatus for manipulating calibrating dies (4; 4a, 4b), configured as a movable second manipulating device (18), comprising at least one calibrating die lifting apparatus (16, 17) for receiving calibrating dies (4; 4a, 4b).

13. An apparatus according to claim 12, characterized in that the second manipulating device (18) comprises at least one displacement unit (19, 20), preferably with roller or slide bearing, for the calibrating die (4; 4a, 4b).

14. An apparatus according to claim 12 or 13, characterized in that the calibrating die lifting apparatus (16, 17) comprises a first lifting arm (16a) for receiving a first calibrating die (4a) and a second lifting arm (17a) for receiving a second calibrating die (4b).

15. An apparatus according to claim 14, characterized in that the first and the second lifting arm (16a, 17a) of the calibrating die lifting apparatus (16, 17) can be moved independent from each other.

16. An apparatus according to one of the claims 12 to 15, characterized in that the second manipulating device (18) can be docked and fixed to the calibrating table (5).

17. An apparatus according to one of the claims 12 to 16, characterized in that the calibrating die (4; 4a, 4b) can be connected to cooling water and/or vacuum supply lines (7, 8) of the calibrating table (5) by way of an automatic coupling unit (28).

18. An apparatus according to one of the claims 12 to 17, characterized in that the second manipulating device (18) is provided with only one lifting device and the changing process is supported by a transversal displacement unit (30).

19. An apparatus according to one of the claims 12 to 18, characterized in that the transversal displacement unit (30) is arranged between the calibrating die (4) and the mounting frame (27) of the calibrating table (5) and the calibrating die (4) rests on the transversal displacement unit (30) by vertical lowering of the mounting frame (27) and the cooling water and vacuum supply lines (7, 8) are severed as a result.

20. An apparatus according to one of the claims 8 to 17, characterized in that the first and/or second manipulating device (9, 18) is provided with an automotive configuration.
